(19) United States
(12) Patent Application Publication
(10) Pub. No.: US 2017/0133166 A1
(43) Pub. Date: May 11, 2017

(54) METHOD FOR FABRICATING AN ELECTROCHEMICAL DEVICE, SUCH AS AN ELECTROCHROMIC SYSTEM OR AN ENERGY STORAGE SYSTEM, FOR EXAMPLE A MICROBATTERY, A BATTERY OR A SUPERCAPACITOR

(71) Applicant: COMMISSARIAT À L'ENERGIE ATOMIQUE ET AUX ENERGIES ALTERNATIVES, Paris (FR)

(72) Inventors: Sami OUKASSI, Saint-Egreve (FR); Frédéric GAILLARD, Voiron (FR); Raphaël SALOT, Lans en Vercors (FR)

(73) Assignee: COMMISSARIAT À L'ENERGIE ATOMIQUE ET AUX ENERGIES ALTERNATIVES, Paris (FR)

(21) Appl. No.: 15/346,378

(22) Filed: Nov. 8, 2016

(30) Foreign Application Priority Data
Nov. 10, 2015 (FR) 1560758

(51) Int. Cl. H01G 11/84; H01G 11/66; H01G 11/58; H01M 2/20; H01M 10/0525

(52) U.S. Cl. CPC H01G 11/84; H01M 2/204; H01M 10/0525; H01G 11/58; H01G 11/66; H01M 2220/30

(57) ABSTRACT

Method for fabricating an electrochemical device, such as an electrochromic system or an energy storage system, including the following successive steps: providing a substrate; forming n individual entities on the substrate, with n greater than or equal to 2, each individual entity including: a first current collector, of a first polarity, a first electrode, an ionically conductive and electrically insulating thin layer, a second electrode, a second current collector, of a second polarity; cutting the substrate, cutting being performed so as to have at least x complete individual entities, on the substrate, with x greater than or equal to 2 and x less than or equal to n; electrically connecting the current collectors of the same polarity of the x complete individual entities in parallel.

### FIELD OF THE INVENTION

The invention relates to a method for fabricating electrochemical devices, such as electrochromic systems or energy storage systems, for example microbatteries, batteries or supercapacitors, and to an electrochemical device obtained in this way.

### STATE OF THE ART

Electrochromic systems and energy storage devices, such as batteries, microbatteries, or supercapacitors, are conventionally formed by a substrate 1 on which at least one stack of active layers 2 is arranged, said stack comprising at least a first electrode 3 connected to a first current collector 4 and at least a second electrode 5 connected to a second current collector 6 (FIG. 1). The electrodes are separated by an electrolytic membrane 7.

Migration of one or more ions between the two electrodes 3, 5 through the electrolyte enables energy to be stored or to be delivered (case of batteries, microbatteries/supercapacitors) or the properties of the component to be changed, this involving the optical properties in the case of electrochromic components.

These devices are particularly rugged and present good electric performances (stability during cycling, self-discharge).

They can be produced in different forms, with different sizes and have different connectors, depending on the targeted applications.

To produce such devices, the most widespread method, for example described in the document U.S. Pat. No. 6,764,525, consists in effectuating successive depositions of active layers through a mechanical mask placed on the substrate. The hollowed areas of the mask correspond to the deposition areas on the substrate and give the deposited layer the required shape.

However, the use of mechanical masks presents several limitations preventing high-yield, low-cost mass production, in particular:
a high investment cost due to fabrication, alignment and cleaning of the mechanical masks; this cost being proportional to the size of the mask and/or of the substrate involved,
a high fabrication cost of the electrochemical devices, on account of the low integration density (number of products per substrate) inherent to the use of mechanical masks,
a low production rate essentially on account of low deposition rates induced by limitations related to the presence of masks (for example temperature),
a low yield: the use of mechanical masks gives rise to particulate contamination over time at the level of the deposition chambers and of the substrates, which can lead to malfunctioning of the products and to a drop in the yield rate.

In order to remedy these shortcomings, other fabrication methods have been developed. These methods do not use mechanical masks and are based on two essential features: (i) grouping the deposition steps in order to pattern several layers simultaneously and (ii) replacing the conventional pattern definition method (mechanical mask) by another method which is simpler and faster.

The documents WO2014099974 and EP2044642 describe fabrication methods which consist (i) in depositing, in a first stage, all the active layers (a first current collector, a first electrode, an electrolyte, a second electrode and a second current collector) so as to form a single stack of active layers on the whole of the surface of the substrate (blanket deposition mode), and (ii) in performing patterning of the layers without using masks, for example by laser ablation, so as to form several distinct stacks of active layers.

In the document GB2492971, in step (ii) the layers are simultaneously patterned and connected by means of a head coupling a laser and a deposition nozzle of ink jet type.

In these methods, the absence of masks or the use of masks other than mechanical masks (laser or photolithography/etching) enables costs to be reduced, the integration density to be improved, and a yield independent from the particulate contamination of the masks to be obtained. The production rate is no longer limited by deposition parameters of the “mechanical mask” mode. Higher deposition rates can be obtained, but certain deposition steps may nevertheless limit the speed of the method.

However, these methods also present certain limitations. In particular, each active layer is deposited on the whole of the surface of the substrate, and if a continuity defect exists in one of the layers, this defect can spread to the whole of the microbatteries formed after patterning from the same single layer. If the defect is present in the electrolyte layer, the first and second electrodes may be in contact, causing a short-circuit between the first and second electrodes, uncontrolled migration of lithium ions between the two electrodes, or even irreversible saturation of one of the two electrodes with ions which would render the patterned future batteries sharing the same defect area defective.

The defect can extend laterally (isotropic and fast ion diffusion) to cover a larger area of the substrate and further impact future batteries at the time of patterning.

In certain other cases, due to mechanical stresses accompanying diffusion, it is possible to have a more or less extensive delamination of the layers, and it is even possible for the fabrication method to be stopped.

These different phenomena tend to impair the yield of the fabrication method to a considerable extent.

Furthermore, each of the patterning steps (masks, etching, ablation, etc.) is specific to a type of product of particular shape and size.

In the case where several different products have to be fabricated, adjustment of the parameters of the different steps leads to a slow-down of the production rate.

The document FR 2977380 describes fabrication method of a batteries device with testing of the operation of the batteries before their electric connection so as not to connect non-functional batteries.

The document U.S. Pat. No. 5,350,645 proposes to produce a multitude of identical lithium batteries on a substrate. After it has been fabricated, the substrate is cut to dissociate the different individual batteries.

The document US 2008/0263855 proposes forming batteries on two opposite surfaces of a substrate or in adjacent manner on a single surface of a substrate. After it has been fabricated, the substrate is cut to dissociate the different individual batteries. As an alternative, groups of batteries are formed.

A real requirement therefore exists to overcome these limitations so as to be able to industrialise a fabrication method of such devices on a large scale.

### OBJECT OF THE INVENTION

The object of the invention is to remedy the shortcomings of the prior art, and in particular to propose a fabrication method of electrochemical devices, such as electrochromic systems or energy storage systems, for example microbatteries, batteries or supercapacitors enabling high-yield, low-cost mass production of the electrochemical devices of different shapes and sizes.

This object is achieved by a fabrication method of electrochemical devices, such as electrochromic systems or energy storage systems, for example microbatteries, batteries or supercapacitors, comprising the following successive steps:

a) providing a substrate,
b) forming n individual entities on the substrate, with n greater than or equal to 2, each individual entity comprising:
a first current collector, of a first polarity,
a first electrode,
an ionically conductive and electrically insulating thin layer,
a second electrode,
a second current collector, of a second polarity,
   c) cutting the substrate, cutting being performed so as to have at least x complete individual entities on the substrate, with x greater than or equal to 2 and x less than or equal to n,
   d) electrically connecting the current collectors of the same polarity of the x complete individual entities in parallel.

This object is also achieved by an electrochemical device, such as an electrochromic system or an energy storage system, for example a microbattery, a battery or a supercapacitor, comprising:
a substrate,
at least x complete individual entities, arranged on the substrate, with x greater than or equal to 2, each individual entity comprising:
   a first current collector, of a first polarity,
   a first electrode,
   an ionically conductive and electrically insulating thin layer,
   a second electrode,
   a second current collector, of a second polarity,
      the current collectors of the same polarity of the complete individual entities being electrically connected in parallel.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents, in schematic manner, in cross-section, an electrochemical device, such as an electrochromic system or an energy storage system, for example a microbattery, a battery or a supercapacitor,

FIGS. 2a to 2d represent, in schematic manner and in top view, a substrate comprising several individual entities according to different steps of a method for fabricating an electrochemical device according to the invention,

FIGS. 2e to 2g represent, in schematic manner, the electric representation of the substrates represented in FIGS. 2b to 2d,

FIGS. 3a to 3c represent, in schematic manner and in top view, individual entities of different shapes according to different embodiments of the invention,

FIGS. 4a to 4c represent, in schematic manner and in cross-section, a substrate comprising one or more individual entities during different steps of the fabrication method,

FIG. 4d represents, in schematic manner and in three dimensions, a substrate comprising several individual entities and the connections of the current collectors of the same polarity, according to an embodiment,

FIGS. 5a to 5c represent, in schematic manner and in cross-section, a substrate comprising one or more individual entities during different steps of the fabrication method,

FIG. 5d represents, in schematic manner and in three dimensions, a substrate comprising several individual entities and the connections of the current collectors of the same polarity, according to an embodiment.

### DESCRIPTION OF A PREFERRED EMBODIMENT OF THE INVENTION

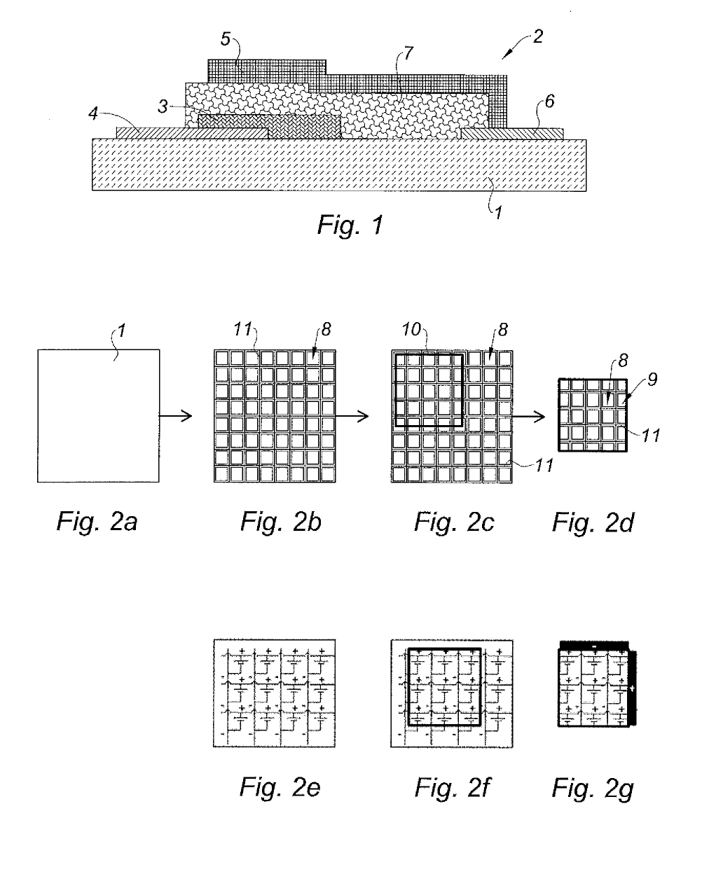

The method for fabricating an electrochemical device, such as an electrochromic system or an energy storage system, for example a microbattery, a battery or a supercapacitor, comprises the following successive steps (FIGS. 2a to 2g):

a) providing a substrate 1 provided with first and second surfaces,
b) forming n individual entities 8 on the substrate 1, with n greater than or equal to 2, each individual entity 8 comprising:
a first current collector 4, of a first polarity,
a first electrode 3,
an ionically conductive and electrically insulating thin layer 7,
a second electrode 5,
a second current collector 6, of a second polarity,
   c) cutting the substrate 1, cutting being performed so as to have at least x complete individual entities 8 on the substrate, with x an integer greater than or equal to 2 and x less than or equal to n,
   d) electrically connecting the current collectors of the same polarity of the x complete individual entities 8 in parallel.

Unlike the prior art, the final device is therefore not formed by a single entity patterned to the required size but by several individual entities 8 connected in parallel. Each complete individual entity 8 presents a functional property Xi. The individual entities 8 are connected in parallel so as to give the electrochemical device a functional property Xf.

The functional properties Xi, Xf are electric, optic or electrochemical properties. The properties of the final device correspond to the association of the properties of the connected individual entities 8.

With such a method, it is possible to fabricate different sizes of final electrochemical devices from a single substrate 1, covered with advantageously identical individual entities 8, the size of the cut simply having to be modified to have the required shape of the required product.

Advantageously, the substrate provided in step a) is made from silicon, glass, ceramics or metal (FIG. 2a). The substrate, also called support substrate, is a monoblock part forming a continuous element.

The substrate is advantageously cleaned, for example by means of a chemical process, in order to eliminate the residues and/or particles which may be present on its surface. A heat treatment step can also be applied to reduce the residual stresses and/or as a complement to the cleaning step.

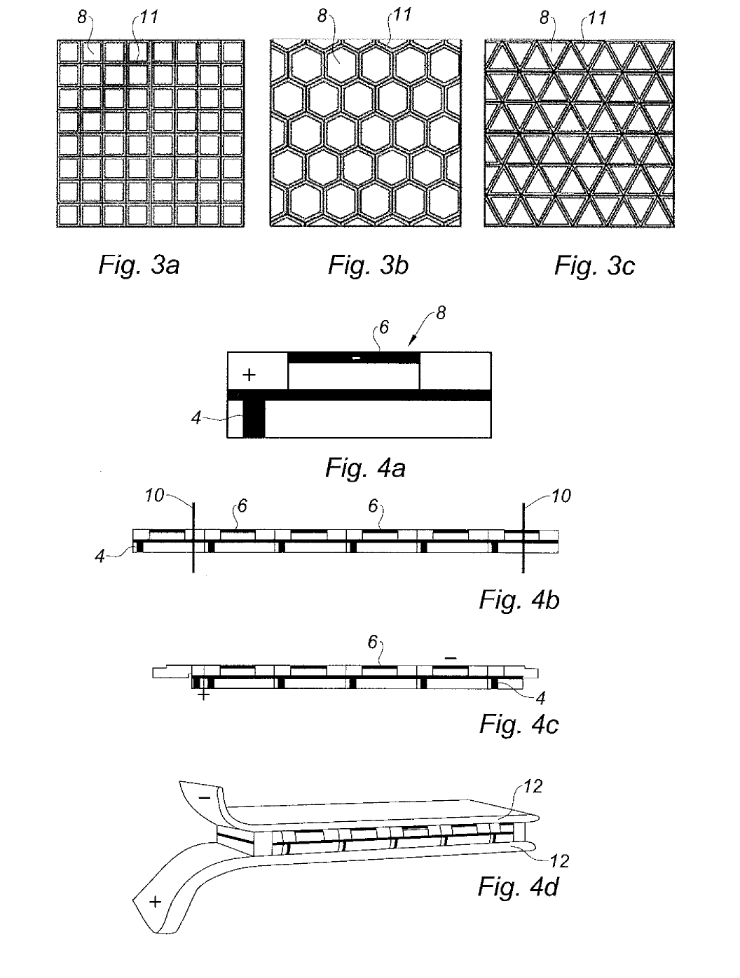

During step b), a first group of individual entities 8 is formed on the substrate (FIGS. 2b and 2e). The individual entities 8 can also be called individual cells. The individual entities 8 can have several possible shapes. They advantageously have the shape of a polygon such as a rectangle or a rhomb. Even more advantageously, they have the shape of a regular polygon, such as a square, an equilateral triangle or a hexagon (FIGS. 3a to 3c).

The individual entities 8 present smaller dimensions than those of the final product be fabricated or than those of the final products if there are several products on the same production line and in particular on the substrate or substrates.

The individual entities 8 are advantageously identical.

They could also, according to another embodiment, be different.

In advantageous manner, the individual entities 8 of the first group or a part of the individual entities 8 of the first group are aligned in a first direction and in advantageous manner with a first repetition pitch. The first group can comprise different individual entities which form a pattern repeated periodically in the first direction. In the example illustrated in FIG. 2b, the individual entities are aligned in two directions and advantageously in two perpendicular directions. The individual entities are repeated with two repetition pitches which can be identical or different.

Formation of the individual entities 8 consists of a succession of deposition and patterning steps of the different layers forming the electrochemical stack of the individual entities 8.

The depositions of the materials forming the different layers of the stack can be performed by vacuum deposition techniques, for example by physical vapor deposition (PVD), chemical vapor deposition (CVD), plasma enhanced chemical vapor deposition (PECVD), metal organic chemical vapor deposition (MOCVD), etc.

The patterning enables a certain number of individual entities 8 to be defined. The individual entities are advantageously characterised by the fact that they have the same geometric properties (dimensions, shape, and thickness of the layers). These individual entities 8 present the same functional properties (electric, optic, electrochemical) as the component to be produced, in proportion to the ratio of the geometries of the two objects.

In the case where the individual entities are identical, the performance of the product obtained is equal to the sum of the contributions of the individual entities, and the performance of the final product corresponds to the mean of the uniform performances of the individual entities. The performance of the product does not depend on a certain category of entities.

Management of the fabrication method is simpler: the variation of the size of the final product does not have any impact on the paving used.

In the case where several sizes or geometries are used, a certain paving configuration per product tends to be preferred, but it is nevertheless possible for the paving to be dependent on the product and not to be generalised to all the products.

The patterning can be performed by techniques originating from the microelectronics field, for example by a photolithography step followed by an etching step which can be performed by wet method or by plasma. The patterning can also be performed by laser ablation.

The materials forming the stack are to be chosen by the person skilled in the art according to the required properties.

In the case of microbatteries for example, the deposition/patterning steps of at least a first current collector, a first electrode, an electrolyte, a second electrode, and a second current collector are necessary to finalise this phase. An example of a stack of microbatteries can for example be Pt (0.1 μm)/LiCoO₂ (10 μm)/LiPON (2 μm)/Si (0.1 μm)/Cu (100 nm) respectively for the following parts: the first current collector, the first electrode, the electrolyte, the second electrode, and the second current collector.

The individual entities 8 are advantageously regularly spaced apart from one another. The spaces between the individual entities 8 form cutting paths 11, also called separation areas.

When the individual entities 8 are square, they form a matrix of individual entities 8.

The surface of the space 11 between the individual entities 8 represents less than 20% of the surface of the individual entities, preferentially less than 10% of the surface of the individual entities, and even more preferentially less than 5% of the surface of the individual entities. The surface of the cutting paths 11 is therefore sufficient to perform cutting and the surface loss is limited. The device advantageously remains compact. In advantageous manner, the distance separating two adjacent individual entities 8 is smaller than the width of the cutting device or cutting tool, for example a saw or a laser beam, used to cut the substrate. Thus, when the cutting step is performed, the cutting device forms at least one non-complete individual entity 9. In preferential manner, the width of a complete individual entity 8 is larger than the width of the cutting device, i.e. larger than the width of the cutting area so as to cut a single individual entity 8 perpendicularly to the cutting direction.

During step c), the substrate 1 is cut in order to give the final product the required size and shape. Cutting is performed along a cutting line 10 (FIGS. 2c and 2f).

The substrate 1 is preferably cut in the shape of a square, a rectangle, an equilateral triangle or a hexagon.

The complete and functional individual entities 8 present on the cut substrate are adjacent. They form a block at least in the centre of the cut substrate. Depending on the cutting, the block can extend up to the periphery of the cut substrate.

In the methods described in the state of the art, the cutting phase is performed on substrates where the shape of the final product was obtained previously by a patterning step. The patterning step was performed by means of one or more masks specific to the final product which is complicated and costly.

In the method of the invention, it is the cutting step which gives the final shape of the product. The number of individual entities 8 simply has to be chosen according to the size and properties of the final device.

This cutting step can be performed for example by laser ablation or by chemical etching. In other words, to form different electrochemical devices, it is possible to use several substrates presenting the same paving of individual entities. By cutting the substrates differently, it is possible to form different electrochemical devices from one and the same substrate.

During the cutting step, the substrate is cut so as to divide the first group of individual entities into at least second and third different groups of individual entities, i.e. the second and third groups of individual entities do not share any complete individual entity. The second and third groups of individual entities each comprise a plurality of individual entities which originate from the first group of individual entities. In advantageous manner, the first group of individual entities only comprises complete individual entities.

Depending on the embodiments, the second and third groups of individual entities comprise the same number of complete individual entities and possibly the same number of non-complete individual entities. In advantageous manner, the second and third groups of individual entities present the same surface area and advantageously have the same shape. As an alternative, the second and third groups of individual entities present the same surface area but have different shapes. It is further possible to provide for the second and third groups of individual entities to present different surface areas.

Two embodiments can be considered.

In a first embodiment, cutting is performed only in the cutting paths 11. The individual entities are therefore not cut: the cuffing line 10 follows the cutting paths 11.

This embodiment is obtained when the shape of the individual entities and the elementary patterning pitch enable “paving” of all the shapes of the products involved. What is meant by paving is covering a given affine space, by means of identical figures or patterns, having only parts of their boundaries in common two by two.

For example, if we take the case of two final products of square shape with a first product which has dimensions of 1 cm×1 cm and a second product having dimensions of 2.2 cm×2.2 cm and if the size of the individual entities is 0.2 cm×0.2 cm, it is possible to make a cut only in the space 11 between the individual entities 8.

Advantageously, in this embodiment, the losses resulting from cutting are reduced as no individual entity 8 is cut. This does however impose having relatively large spaces between the individual entities in order to allow a cutting device to pass without damaging the individual entities.

In the second embodiment, the cutting line 10 passes both in the cutting paths 11 and through the individual entities 8, which are therefore cut.

The cutting results in a cut substrate 1 comprising both complete individual entities 8 and non-complete individual entities 9. The complete individual entities 8 are said to be functional and the non-complete entities 9 are by opposition non-functional. In advantageous manner, the at least second and third groups of individual entities comprise complete and non-complete individual entities. The non-complete individual entities originate from the cutting step and are located at the periphery of the second group and at the periphery of the third group of individual entities. The second group of individual entities is a monoblock element comprising a plurality of individual entities and at least one non-complete individual entity originating from cutting of the substrate. The same is advantageously the case for the third group of individual entities.

In advantageous manner, the non-complete individual entities are exclusively formed at the periphery of the second and third groups of individual entities so that a non-complete individual entity is never completely surrounded by complete or non-complete individual entities.

In a particular embodiment, the periphery of the second group of individual entities is formed exclusively by non-complete individual entities. As an alternative, the periphery of the second group of individual entities is formed by non-complete individual entities and complete individual entities.

The same can be the case for the third group of individual entities. In an advantageous embodiment, the second group and third group of individual entities share a common side formed by a group of non-complete individual entities as they are cut to define the second group and the third group from the first group.

This embodiment with cutting of complete and functional individual entities to form second and third groups enables for example the separation distance between all the individual entities to be reduced as the paving comprises less predefined cutting lines than in the prior art or no longer comprises any predefined cutting lines, i.e. large areas devoid of individual entities. By eliminating the cutting lines, the integration density of the individual entities is increased and it is possible to form more individual entities on any one substrate. The inventors observed that more electrochemical devices were able to be formed on any one substrate. In the absence of any cutting line, cutting of the substrate is performed by only cutting complete individual entities to form non-complete individual entities.

Advantageously, the non-complete individual entities 9 will not be electrically connected in step d).

This configuration can arise in the case where the dimensions and/or the shape of the individual entities 8 does not allow paving of all the shapes of the final products involved.

For example, if we take the case of two products of square shape with a first product having the dimensions 1 cm×1 cm and a second product having the dimensions 2.2 cm×2.2 cm and if the size of the individual entities is 0.3 cm×0.3 cm, it is then not possible to make a cut only in separation area 11. The shape of the individual entities 8 also has an influence on the cutting. For example, with individual entities 8 of triangular shape, cutting of the individual cells 8 for a final device of square shape will also be obtained.

In this embodiment, after step c), and before step d), a cleaning step is advantageously performed to remove at least part of the stacks of active layers of the cut individual entities 9. Preferentially, the non-complete individual entities are eliminated.

Preferentially, to eliminate the non-functional stacks, the non-complete and non-functional individual entities 9 are etched before the connection step d). The etching is a selective etching enabling only the non-complete individual entities to be etched while leaving the complete and functional individual entities intact. The etching is advantageously performed by wet method by immersing all of the substrate in a chemical solution which etches only the materials made accessible by the cutting.

In this embodiment, the economic loss will be only related to the number of individual entities through which the cutting path passes, the other individual entities remaining intact and functional.

The final product will thus present a “paving” of the whole of its shape by individual entities 8, with a perimeter formed by “complete patterns or parts of missing patterns”. Although this perimeter constitutes a loss of active surface, such devices present the advantage of being able to achieve products of different shapes/dimensions while at the same time minimising the number of technological steps specific to each of the final products involved. Only the cutting step is specific.

It is then possible with two identical substrates, i.e. comprising the same paving of individual entities, to produce second and third groups of individual entities that are different in their number and/or in their shape. The substrate fabrication method can be optimised for fabrication of the individual entities 8 and the substrate cutting step enables them to be specialised in order to fabricate the required electrochemical devices. This approach is different from that of the prior art where the substrate is specialised as from the paving step which results in higher production costs and difficulties to optimise the occupied surface of the substrate. This optimisation problem is all the more critical as electrochemical devices that are different in shape have to be produced on one and the same substrate.

The patterning phase is generic to all the products involved. The patterning is not subjected to specific design rules in relation with given products: it does not take account of any geometric data specific to a product.

It is also possible to use different arrangements of the individual entities and different sizes of separation areas, i.e. a different paving, for any one product. The size and positioning of the individual entities depend on the final product and generally require prior knowledge of the dimensions of the final product.

If one of the layers of the stack presents a defect, a small proportion of individual entities 8 may be defective. Advantageously, as the individual entities 8 are connected in parallel, the number of devices impacted by said defect will be limited.

In the case of an electrochemical device formed full wafer by a single element, the defect is propagated to the whole of the device which will therefore not be functional. In the case of an electrochemical device formed by a plurality of individual entities, the defect will remain confined for example in a single individual entity, and the electrochemical device will however be able to be functional.

In step d (FIGS. 2d and 2g), the different complete and functional individual entities 8 of one and the same cut product are connected in parallel with one another to obtain the functional characteristics, and in particular the electrochemical properties, required for the final product.

Parallel connection means that the equivalent characteristics of all the individual entities 8 are retrieved and assembled to obtain the same characteristics as a product of the same shape/size fabricated by processes of the prior art, i.e. with a single undivided block.

Advantageously, the non-complete individual entities 9 are not electrically connected to the complete individual entities 8.

Parallel connection of the individual entities 8 of the second group of individual entities enables a first electrochemical device to be formed. Parallel connection of the individual entities 8 of the third group of individual entities enables a second electrochemical device to be formed. Depending on the embodiments, the first electrochemical device is formed before the second electrochemical device. As an alternative, the first and second electrochemical devices are formed simultaneously.

Parallel connection consists in electrically connecting the current collectors of the same polarity to one another.

The position of the connectors will depend on the position and patterning of the current collectors.

According to a first embodiment (FIGS. 4a to 4d), the first current collector 4 is formed on the first surface of the substrate 1. The stack formed by the first electrode 3, ionically conductive and electrically insulating thin layer 7, second electrode 5, and second current collector 6, of a second polarity, is formed on the second surface of the substrate 1. There is one polarity per substrate surface. In this configuration, the substrate is electrically insulating. The depositions of these different elements, and in particular the first electrode 3, the ionically conductive and electrically insulating thin layer 7, and the second electrode 5, are advantageously conformal.

In this embodiment, after cutting along a cutting line 10 (FIG. 4b) and etching (FIG. 4c), the current collectors 4, 6 arranged on the same surface of the substrate 1 are electrically connected by an electrically conductive layer 12 (FIG. 4d). Parallel connection means that all the current collectors present on the same surface of the substrate are placed in contact, this being applicable for both surfaces.

The electrically conductive layer 12 is for example produced by a deposition technique of sputtering, spraying, ink jet or evaporation type. The deposited layer is for example metallic and advantageously made from Ti, Cu, Ni, or Al. According to another embodiment, the electrically conductive layer 12 is achieved by transfer of an electrically conductive film onto the current collectors of the same polarity.

What is meant by electrically conductive film is that the film comprises at least one conductive surface, this surface being designed to be in contact with the current collectors of the same polarity.

The electrically conductive film is advantageously transferred by lamination or by a technique of “pick and place” type, sometimes able to be called die bond technique.

The electrically conductive film is a metallic film, for example made from Cu, Ni, Ti, or Al, or an electrically insulating film covered by an electrically conductive layer.

In the latter case, the electrically insulating film is thin to be able to give it a certain flexibility to enable transfer of the film onto the substrate. The film is for example made from polymer, glass, or ceramic. The conductive layer is preferably a polymer or a glue or a film such as an anisotropic conductive film (ACF).

The film can also be an electrically conductive tape.

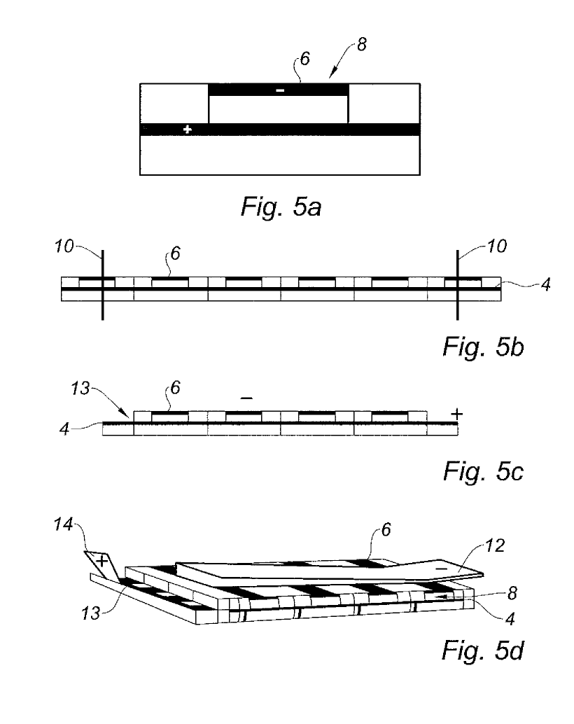

According to another embodiment (FIGS. 5a to 5d), the first current collector 4, first electrode 3, ionically conductive and electrically insulating thin layer 7, second electrode 5, and second current collector 6, of a second polarity, are formed on the same surface of the substrate, either the first surface or the second surface of the substrate.

In this embodiment, the first and second current collectors 4, 6 of the individual entities 8 are grouped together on one and the same surface of the substrate. The first current collector 4 is advantageously formed by deposition of a continuous electrically conductive film on the substrate 1. The first current collector is common to all the individual entities 8. Advantageously, it does not need to be patterned. Only the second current collectors 6 are patterned (FIG. 5d).

After cutting along the cutting line 10 (FIG. 5b) and etching (FIG. 5c), the current collectors of the same polarity are connected.

The second current collectors 6 are connected to one another by an electrically conductive layer 12 (FIG. 5d). The electrically conductive layer 12 can be produced as described in the foregoing.

To connect the first current collectors to one another, several embodiments are possible.

During the cutting step, the first current collector 4 that is continuous and common to all the individual entities is freed. The contact can be made on the periphery of the cut substrate, at the level of the cut, if the surface of the contact is sufficient.

According to another alternative, the cutting step comprises passage of two laser beams. The first beam is configured to stop on the outer surface of the first current collector 4 to release a contact area 13. What is meant by outer surface is the surface of the first current collector 4 that is opposite from the substrate 1.

The method thus comprises a step during which the first current collector 4 at the periphery of the cutting area is made accessible. This accessibility is advantageously obtained by patterning of the layer or layers located above the current collector, which can be performed for example by laser ablation or by etching.

The second laser beam passes completely through the substrate 1 to make the cut.

The order in which the two laser beams are passed can be reversed.

The contact connection on the first current collector 4 common to the individual entities 8 is made for example by means of an electrically conductive pad 14, positioned in the freed contact area 13 (FIG. 5d).

In the methods of the prior art, the presence of a single defect results in degradation of all of the devices constructed on said substrate. In addition, only the deposition steps can be common to several products (of different size and/or shape), which results in a high production cost if there is a multiplication of the products.

The method for fabricating such an electrochemical device, according to the invention, implements successive phases of:
deposition/patterning of several individual entities 8 on a single substrate 1 so as to form a substrate 1 composed of several individual entities 8 of the same size and the same shape,
cutting the substrate 1 according to the shape and dimensions of the product or products involved,
parallel connection of the individual entities 8 constituting the final product.

In this method, the risk of degradation at the level of the substrate is eliminated. Furthermore, both the deposition and patterning steps are common to a set of different products, which enables fabrication costs to be reduced. It is in fact possible to produce different sizes of final devices from a single substrate covered by individual entities of the same dimension, the size of the cut simply having to be modified to have the required shape of the required product.

The electrochemical device, such as an electrochromic system or an energy storage system, for example a microbattery, a battery or a supercapacitor, obtained by this method comprises:
a substrate 1 provided with first and second surfaces,
at least x complete individual entities 8, arranged on the substrate 1, with x an integer greater than or equal to 2, each individual entity 8 comprising:
   a first current collector 4, of a first polarity,
   a first electrode 3,
   an ionically conductive and electrically insulating thin layer 7,
   a second electrode 5,
   a second current collector 6, of a second polarity.

The current collectors 4, 6 of the same polarity of the complete individual entities 8 are electrically connected in parallel, i.e. all the first current collectors 4 of the individual entities 8 are electrically connected in parallel and all the second current collectors 6 of the individual entities 8 are electrically connected in parallel.

A microbattery is for example formed from a plurality of complete individual entities 8 connected in parallel.

The individual entities 8 are advantageously identical.

The individual entities 8 advantageously have the shape of a square, a rectangle, a rhomb, an equilateral triangle or a hexagon.

The surface of the space between the individual entities 8 advantageously represents less than 20% of the surface of the individual entities, preferably less than 10% of the surface of the individual entities, and even more preferentially less than 5% of the surface of the individual entities.

In the microbafteries, the positive electrode 3 is formed by a layer of lithium insertion material such as TiOS, TiS₂, LiTiOS, LiTiS₂, LiCoO₂, V₂O₅ etc.

The anode 5 is formed by a material constituted exclusively by metallic lithium (Li-metal battery) or by a lithiated insertion material (NiO₂, SnO, Si, Ge, C etc.) (lithium-ion battery).

The electrolyte layer 8 is preferably formed by lithium and phosphorus oxynitride (LiPON). It could also be made from LiPONB or LiSiCON.

In the case of an electrochromic system, the electrochromic active electrode is formed by an electrochromic material able to reversibly and simultaneously insert ions and electrons to give a persistent coloration of the corresponding oxidation state.

The active electrode 5 and/or the counter-electrode 4 is an electrode made from tungsten oxide, iridium oxide, vanadium oxide or molybdenum oxide.

The active electrode 5 is preferentially made from tungsten oxide or from molybdenum oxide.

The counter-electrode 3 is preferentially made from iridium oxide or from vanadium oxide.

The solid layer of ionically conductive electrolyte 8 is made from a lithium base, for example from lithium nitride (Li₃N), LiPON, LiSiPON, or from LiBON, etc.

The electrodes 3, 5 of the microcapacitor can be carbon-based or made from metal oxides such as RuO₂, IrO₂, TaO₂ or MnO₂. The electrolyte is for example a vitreous material of the same type as that of the microbatteries.

In order to protect the active materials of the electrodes from the oxygen and moisture present in the air, these devices are advantageously covered by an encapsulation system, not shown, obtained by a stack of protective layers or by the addition of a cover.

The encapsulation layer is for example made from ceramic, polymer, or metal. It can also be formed by a superposition of layers of these different materials.

In the case of an electrochromic system, the encapsulation layer is transparent to light.

Several electrochemical devices, each formed by a plurality of complete individual entities 8, connected in parallel, can then be electrically connected together. This can for example involve association of a microbattery and a supercapacitor.

The cutting step enables several identical or different electrochemical devices to be formed in one and the same substrate. The shape of the electrochemical devices is dissociated from the shape of the individual entities as at least one individual entity is cut in order to form an electrochemical device having a required shape. This specificity enables electrochemical devices having any shape to be formed starting from a substrate or several substrates which comprise the same paving. The shape of the paving is the dissociated from the shape of the electrochemical device.

1. Method for fabricating at least first and second electrochemical devices, such as electrochromic systems or energy storage systems, for example microbatteries, batteries or supercapacitors, comprising the following successive steps:
a) providing a substrate comprising a first group of complete individual entities, each complete individual entity comprising:
a first current collector of a first polarity,
a first electrode,
an ionically conductive and electrically insulating thin layer,
a second electrode,
a second current collector of a second polarity,
b) cutting the substrate so as to form at least second and third groups of individual entities each comprising a plurality of complete individual entities from the first group of complete individual entities, cutting being performed so as to form a plurality of non-complete individual entities in each of the second and third groups of individual entities, all or part of the individual entities located at a periphery of the second group of individual entities and/or of the third group of individual entities being non-complete individual entities,
c) electrically connecting the first and/or second current collectors of a same polarity of the complete individual entities of the second group of individual entities in parallel without electrically connecting the non-complete individual entities to form the first electrochemical device,
d) electrically connecting the first and/or second current collectors of a same polarity of the complete individual entities of the third group of individual entities in parallel without electrically connecting the non-complete individual entities to form the second electrochemical device.

2. Method according to claim 1, wherein, in step b), the substrate is cut in the shape of a square, a rectangle, an equilateral triangle or a hexagon.

3. Method according to claim 1, wherein a surface of a space between the complete individual entities represents less than 20% of the surface of the complete individual entities.

4. Method according to claim 3, wherein the surface of the space between the complete individual entities represents less than 10% of the surface of the complete individual entities.

5. Method according to claim 4, wherein the surface of the space between the complete individual entities represents less than 5% of the surface of the complete individual entities.

6. Method according to claim 1, wherein the distance separating two adjacent individual entities is smaller than a width of the cutting device during the cutting step of the substrate.

7. Method according to claim 1, wherein after step b), and before steps c) and d), the non-complete individual entities are eliminated.

8. Method according to claim 7, wherein the non-complete individual entities are eliminated by an etching step.

9. Method according to claim 8, wherein the non-complete individual entities are eliminated by a wet etching method.

10. Method according to claim 1, wherein the individual entities are regularly spaced apart from one another.

11. Method according to claim 1, wherein:
the first current collector is formed on a first surface of the substrate,
the first electrode, the ionically conductive and electrically insulating thin layer, the second electrode, and the second current collector of a second polarity, are formed on a second surface of the substrate,
and wherein the current collectors located on a same surface of the substrate are electrically connected by an electrically conductive layer.

12. Method according to claim 1, wherein the first current collector, the first electrode, the ionically conductive and electrically insulating thin layer, the second electrode, and the second current collector of a second polarity, are formed on a same surface of the substrate.

13. Method according to claim 1, wherein the first current collector is formed by deposition of a continuous electrically conductive film on a first surface of the substrate, the first current collector being common to all the individual entities.

14. Method according to claim 1, comprising a step during which the first current collector at a periphery of a cutting area is made accessible.

15. Method according to claim 1, wherein the second current collectors of the complete individual entities are electrically connected by an electrically conductive layer.

16. Method according to claim 15, wherein the electrically conductive layer is a metallic film or an electrically insulating film covered by an electrically conductive layer.

17. Method according to claim 1, wherein the non-complete individual entities are formed by cutting complete individual entities during step b).

18. Electrochemical device, such as an electrochromic system or an energy storage system, for example a microbattery, a battery or a supercapacitor, comprising:
a substrate provided with first and second surfaces,
a plurality of complete individual entities, arranged on the substrate, each complete individual entity comprising:
a first current collector of a first polarity,
a first electrode,
an ionically conductive and electrically insulating thin layer,
a second electrode,
a second current collector of a second polarity,
the current collectors of the same polarity of the complete individual entities being electrically connected in parallel.
at least one non-complete individual entity, located on the substrate, at a periphery of the substrate.

19. Device according to claim 18, wherein the surface of the space between the complete individual entities represents less than 20% of the surface of the complete individual entities, preferably less than 10% of the surface of the complete individual entities, and even more preferentially less than 5% of the surface of the complete individual entities.

20. Device according to claim 18, wherein the individual entities are regularly spaced apart from one another.
